(19) United States
(12) Patent Application Publication
(10) Pub. No.: US 2012/0187186 A1
(43) Pub. Date: Jul. 26, 2012

(54) HOME POSITION METHOD OF SCANNING MODULE AND SCANNER USING THE SAME

(75) Inventors: Meng-Sheng Wu, New Taipei City (TW); Shih-Sen Hsieh, New Taipei City (TW)

(73) Assignees: Kinpo Electronics, Inc., New Taipei City (TW); Cal-Comp Electronics & Communications Company Limited, New Taipei City (TW)

(21) Appl. No.: 13/330,620

(22) Filed: Dec. 19, 2011

(30) Foreign Application Priority Data
Jan. 26, 2011 (TW) 100102937

(51) Int. Cl. G06F 17/00

(52) U.S. Cl. 235/375

(57) ABSTRACT

A home position method of a scanning module and a scanner using the same are provided. The home position method includes: scanning a barcode pattern so as to obtain an image, in which the barcode pattern is set in an area and the area is outside of a flatbed scanning window of the scanner; identifying the image so as to determine whether or not the image is an home position pattern; and when the image is determined to be the home position pattern, setting a scan initial line according to the image and moving the scanning module to the scan initial line.

### CROSS-REFERENCE TO RELATED APPLICATION

This application claims the priority benefit of Taiwan application serial no. 100102937, filed Jan. 26, 2011. The entirety of the above-mentioned patent application is hereby incorporated by reference herein and made a part of this specification.

### BACKGROUND OF THE INVENTION

1. Field of the Invention

The invention relates to a scanner, and more particularly, to a home position method of a scanning module of a scanner.

2. Description of Related Art

In the fundamental structure of a general scanning device, a scanning module will include an optical sensor and a transmission mechanism. The scanning module is used for capturing an image of an object to be scanned. Every time a scan is completed, the scanning module must return to a home position. In a conventional detecting home position method, the scanning module will install a protection wall and a home sensor in a direction moving towards the home position. When the scanning task is done, the transmission mechanism causes the scanning module to move, and when reaching the home position, the home sensor provides a detecting signal so the transmission mechanism stops operating. The scanning module stops at the home position, and waits for the next scanning task to start. However, installing additional components in the scanner increases assembly time and production cost.

Generally, when the scan task is finished, the scanning module will move in a direction towards the home position. However, because of mechanical failure or power failure, the scanning module will not always precisely home position to a specific position, causing the scanning module to only capture a portion of the image of the document, resulting in low scanning quality.

How to resolve the home position problem of conventional scanning modules, simplify the amount and types of components, and achieve a low cost high scan quality scanner is a task looking to be overcome.

### SUMMARY OF THE INVENTION

The invention provides a home position method of a scanning module and a scanner using the same. The home position method does not require additional components, and only adds a barcode pattern. After the scanning module captures an image of the barcode pattern, the scanning module performs a home positioning according to a position of the barcode pattern.

The invention provides a home position method of a scanning module of a scanner. In the method, a barcode pattern is scanned and an image is obtained. The barcode pattern is set in an area outside of a flatbed scanning window of the scanner. The image is identified so as to determine whether the image is a home position pattern. When the image is determined to be the home position pattern, a scan initial line is set according to the image and the scanning module is moved to the scan initial line.

The embodiment further provides a scanner. The scanner includes a flatbed scanning window, a barcode pattern, a scanning module, and a control unit. The barcode pattern is set in an area outside the flatbed scanning window. The scanner includes an image sensor. The control unit is coupled to the scanning module, and is used to control the operation of the scanning module. The scanning module performs scanning towards a barcode pattern, to obtain an image. The control unit identifies the image, so as to determine whether the image is a home position pattern. When the image is determined to be the home position pattern, the control unit sets a scan initial line according to the image and moves the scanning module to the scan initial line.

In an embodiment of the invention, the step of identifying the image includes converting the image into a digital sequence. When the digital sequence satisfies a preset data sequence of the scanner, the scanning module has already captured the home position pattern.

In an embodiment of the invention, the scanner includes a memory. The memory stores a preset data sequence, and is coupled to the control unit. The control unit is further used to control the operation of the memory. When the control unit identifies the image, the image is converted to a digital sequence. When the digital sequence satisfies a preset data sequence, the scanning module has already captured the home position pattern.

In an embodiment of the invention, in the step of setting the scan initial line according to the image includes further continually scanning the barcode pattern, and when the scan width of the image achieves the preset width, the scanning module is moved a first width in a direction opposite to the direction of scanning the barcode pattern, and is accordingly positioned to the scan initial line.

In an embodiment of the invention, the control unit further continuously controls the scanning module to scan the barcode pattern, and when the scan width of the image achieves a preset width, the scanning module is moved a first width in a direction opposite to the direction of scanning the barcode pattern, and is accordingly positioned to the scan initial line in response to the control of the control unit.

In an embodiment of the invention, the first width is greater than a width of the barcode pattern.

In an embodiment of the invention, when the scan width of the image arrives exactly at the preset width, the scanning module is defined as positioned on a first scanning line. The first scanning line is distanced from the scan initial line by the first width. In addition, a second scanning line is defined. The second scanning line is distanced from the first scanning line by a second width, and the second scanning line is distanced from the scan initial line by a third width. The third width is equal to the combination of the first width and the second width. A direction from the first scanning line to the second scanning line is defined as a first direction, and a direction from the first scanning line to the scan initial line is defined as a second direction.

In an embodiment of the invention, the scanning module scans in the first direction, and captures the image.

In an embodiment of the invention, in the step of continually scanning the barcode pattern, when the scan width of the image does not achieve the preset width, the control unit controls the scanning module to move a distance of the third width in the second direction, and then move in the first direction and perform scanning.

In an embodiment of the invention, when the scan width of the image does not achieve the preset width, the control unit controls the scanning module to move a distance of the third width in the second direction, and then move in the first direction and perform scanning.

In an embodiment of the invention, when the number of times the scanning module does not capture the image exceeds a preset value, the control unit controls the scanning module to move a distance of the third width in the second direction, and then move in the first direction and perform scanning.

In an embodiment of the invention, before the step of scanning the barcode pattern further comprises: reading a variable of a memory, and accordingly knowing whether or not a scanning action of a previous document of a scanner ended normally.

In an embodiment of the invention, the memory is further used to store a variable, and the control unit reads the variable, so as to know whether or not a scanning action of a previous document of the scanner ended normally.

In an embodiment of the invention, after the step of reading the variable of the memory further comprises: if the scanning action of the previous document did not have a normal ending, then the scanning module performs scanning in the first direction. On the other hand, if the scanning action of the previous document did have a normal ending, then the scanning module first moves a distance of the third width in the second direction, and then moves in the first direction and performs scanning.

In an embodiment of the invention, when the control unit learns the previous document did not have a normal ending, then the control unit controls the scanning module to perform scanning in the first direction. On the other hand, when the control unit learns the previous document did have a normal ending, then the control unit controls the scanning module to first move a distance of the third width in the second direction, and then move in the first direction and perform scanning.

In an embodiment of the invention, when the control unit controls the scanning module to first move a distance of the third width in the second direction, the control unit reads a set of initialization parameters and exposure time setting values of the memory, and then the control unit controls the scanning module to move in the first direction and perform scanning.

In an embodiment of the invention, the scanner includes a case, an automatic paper-feeding scanning window, and a positioning board. The automatic paper-feeding scanning window and the flatbed scanning window are inserted in the case. The positioning board is disposed on an inner wall of the case. The barcode pattern is disposed on the positioning board, and the positioning board is positioned between the flatbed scanning window and an automatic paper-feeding scanning window.

In an embodiment of the invention, the scanner includes an automatic paper-feeding device and an automatic paper-feeding scanning window. The barcode pattern is disposed on the automatic paper-feeding device, and when the scanning module is below the automatic paper-feeding scanning window, the scanning module captures the image of the barcode pattern.

Based on the above, the home position method of the scanning module and a scanner using the same of the invention does not require an additional protection wall and home sensor, but only requires a barcode pattern. A precise home positioning of the scanning module is performed according to the position of the barcode pattern. Thereby, the number of components is reduced, the assembly process is simplified, and the manufacturing costs are cut down.

To make the above features and advantages of the invention more comprehensible, several embodiments accompanied with drawings are described in detail as follows.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a cross-sectional schematic view of a scanner according to an embodiment of the invention.

FIG. 2 is a block diagram of the scanner of FIG. 1.

FIG. 3 is a schematic view of a barcode pattern according to an embodiment of the invention.

FIG. 4 is a cross-sectional schematic view of a scanner according to another embodiment of the invention.

FIG. 5 is a cross-sectional schematic view of a scanner according to another embodiment of the invention.

FIG. 6 is a flow chart showing a home position method of a scanning module according to an embodiment of the invention.

FIG. 7 is a flow chart showing a home position method of a scanning module according to another embodiment of the invention.

FIG. 8 is a flow chart of the method of identifying the image.

FIG. 9 is a flow chart of the method of identifying the image.

### DESCRIPTION OF EMBODIMENTS

Reference will now be made in detail to the exemplary embodiments of the invention, examples of which are illustrated in the accompanying drawings. In addition, whenever possible, identical or similar reference numbers stand for identical or similar elements in the figures and the embodiments.

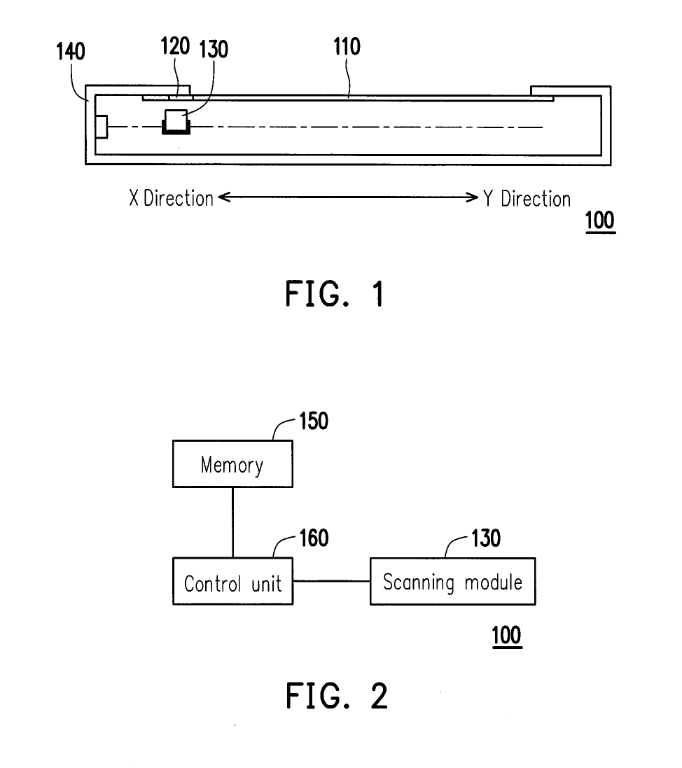

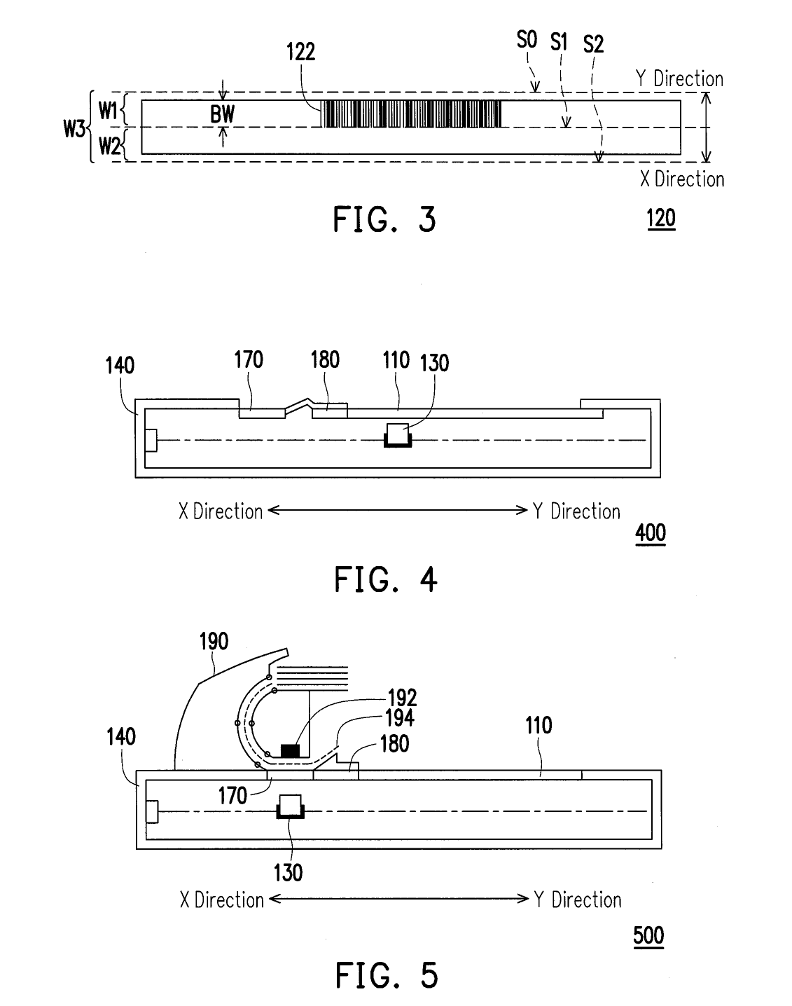

FIG. 1 is a cross-sectional schematic view of a scanner according to an embodiment of the invention. FIG. 2 is a block diagram of the scanner of FIG. 1. FIG. 3 is a schematic view of a barcode pattern according to an embodiment of the invention. Please refer to both FIG. 1 and FIG. 3. The scanner 100 includes a flatbed scanning window 110, a barcode pattern 122, a scanning module 130, a memory 150, and a control unit 160. The scanning module 130 includes an image sensor and a transmission mechanism (not shown). The image sensor may be a contact image sensor (CIS) or a charge coupled device (CCD). The control unit 160 may control the transmission mechanism and cause the scanning module 130 to slide back and forth, to perform image scanning or home positioning of the document. For example, a side of the document to be scanned is placed and faces down on a flatbed scanning window 110. The image of the document is captured by using the scanning module 130 moving along a direction. Thus, the scanner 100 may perform image scanning, and copy or convert the image into an electronic data for storage, or be outputted through paper printing. The scanner 100 may be applied in a multi function peripheral (MEP), a scanning device, a copy machine, or other machines with a document scanning function, but is not limited thereto. A description of the barcode pattern configuration and setting is described below.

### Regarding the Barcode Pattern Configuration

The components of the scanner 100 may be disposed in a case 140. The flatbed scanning window 110 may be a transparent scanning flat top, and used to perform an image scanning assignment for an object to be scanned or a single piece of paper. The barcode pattern 122 is set in an area 120. In general, even though the area 120 and the flatbed scanning window 110 are on the same surface of the scanner 100, the area 120 is not the flatbed scanning window 110 because the document to be scanned may only be scanned on the flatbed scanning window 110 and not in the area 120.

### Regarding the Barcode Pattern Setting

The barcode pattern 122 needs to be arranged according to a specific code regulation, through a combination of black and white lines with different widths, and may be used to show the information of a home position pattern. The barcode pattern 122 may be a one-dimensional barcode such as a 39 standard code (Code39), a Codabar code, a 25 standard code (Code25), an 25 intersecting code (ITF25), a 25 matrix code (Matrix25), a UPC-A code, a UPC-E code, an EAN-13 code (International Product Code EAN-13), an EAN-8 code (International Product Code EAN-8), a Code-B code, an MSI code, a Code 11 code, a Code 93 code, an ISBN code, an ISSN code, a Code128 code (Code128 includes an EAN128 code), or a Code39EMS code (a 39 code specific for EMS) and a PDF417 two-dimensional barcode. However, the code regulation and type of the barcode pattern 122 is not limited thereto. The barcode pattern 122 may expand to another dimension with a readable barcode based on the one-dimensional barcode. Thus, the barcode pattern 122 may be a one-dimensional, two-dimensional, or three-dimensional barcode. The different types of code regulations are well known to those of ordinarily skilled in the art, and will not be repeated herein.

The barcode pattern 122 may be used to identify or determine a home position. Since the difference of the reflectivity of the barcode pattern is great, the barcode pattern 122 has at least the following advantages. It is easy to identify since the original scanning module 130 and the control unit 160 may be directly operated to identify the barcode pattern 122 without the requirement of additional components (such as a protection wall and a home sensor). It is reliable because the black and white lines have great contrast, and an error occurs on average only once each 15000 characters. It is efficient since reading the barcode pattern 122 is fast and the computations are simple. Finally, the cost is low because the barcode pattern 122 only requires a small sticker or is directly printed on a surface (but is not limited thereto).

The memory 150 stores a preset data sequence relating to the barcode pattern 122. The memory 150 may be a flash storage/memory, but is not limited thereto. The control unit 160 is coupled to the scanning module 130 and the memory 150. The control unit 160 controls the operations of the scanning module 130 and the memory 150. When the scanning module 130 needs to perform home positioning, the control unit 160 may control the scanning module 130 to capture an image of the barcode pattern 122, and then the scanning module 130 may transmit the captured image to the control unit 160. The control unit 160 identifies the image of the barcode pattern 122, and may convert the image to a digital sequence. The digital sequence may be a combination sequence of 0 and 1. Then, the control unit 160 compares the digital sequence and the preset data sequence. The preset data sequence may avoid similar barcodes on the document waiting to be scanned. The control unit 160 may determine whether the image is a home position pattern according to the determined result. Next, when the image is determined to be the home position pattern, the control unit 160 defines a scan initial line S0 of the scanning module 130 according to the position of the barcode pattern 122, and moves the scanning module 130 to the scan initial line S0 to complete home positioning.

It should be noted that in an embodiment, the control unit 160 further continuously controls the scanning module 130 to scan the barcode pattern 122, and when the scan width of the image achieves the preset width BW, the scanning module 130 moves a first width W1 in a direction opposite to the direction of scanning the barcode pattern 122, and is accordingly positioned to the scan initial line S0 in response to the control of the control unit 160. The first width W1 may be greater than the width BW of the barcode pattern 122, but is not limited thereto.

### Definitions of the Scan Initial Line So, the First Scanning Line S1, and the Second Scanning Line S2

When the scan width of the image arrives exactly at the preset width BW, the scanning module 130 is defined as positioned on a first scanning line S1, and the first scanning line S1 is distanced from the scan initial line S0 by the first width W1. In addition, a second scanning line S2 is defined, wherein the second scanning line S2 is distanced from the first scanning line S1 by a second width W2, and the second scanning line S2 is distanced from the scan initial line S0 by a third width W3, and the third width W3 is equal to the combination of the first width W1 and the second width W2. A direction from the first scanning line Si to the second scanning line S2 is defined as a first direction (x direction), and a direction from the first scanning line S1 to the scan initial line S0 is defined as a second direction (y direction).

### Regarding the Details of Image Scanning

The following illustrates the details of image scanning. The scanning module 130 scans the barcode pattern 122 in the first direction (x direction). When continually scanning, and when a scan width of the image achieves a preset width BW, the control unit 160 controls the scanning module 130 to move a first width W1 in the second direction (y direction), and accordingly positions the scanning module 130 to the scan initial line S0. When continually scanning, and when a scan width of the image does not achieve a preset width BW, the control unit 160 controls the scanning module 130 to move a third width W3 in the second direction (y direction), and then move in the first direction (x direction) to perform scanning again.

Another example is described hereafter. Because of mechanical failure or power failure, the scanning module 130 will be located at the edge or at a particular position, and thus causing the scanning module 130 to be unable to capture the image a number of times exceeding a preset value. The control unit 160 may control the scanning module 130 to move a distance of the third width W3 in the second direction (y direction), and then move in the first direction (x direction). Next, the control 160 reads a set of initialization parameters and exposure time setting values of the memory 150. Subsequently, the control unit 160 controls the scanning module 130 to move in the first direction (x direction) and perform scanning.

In addition, the memory 150 may be further used to store a variable. The variable is related to the information of the document scanning action. Before performing scanning towards the barcode pattern 122, the control unit 160 may first read the variable, and know accordingly whether or not a scanning action of a previous document of the scanner 100 ended normally. If the control unit 160 learns that the scanning action of the previous document did not have a normal ending, then the scanning module 130 is controlled to perform scanning in the first direction. On the other hand, if the control unit 160 learns the scanning action of the previous document did have a normal ending, then the scanning module 130 is controlled to first move a distance of the third width W3 in the second direction (y direction), and then move in the first direction (x direction) and perform scanning.

### Regarding the Barcode Pattern and Other Possible Disposing Locations

FIG. 4 is a cross-sectional schematic view of a scanner according to another embodiment of the invention. Please refer to FIG. 4, when a scanner 400 is used in an MFP, the scanner 400 further includes an automatic document feeder (ADF) scanning window 170 and a positioning board 180. The automatic paper-feeding scanning window 170 and the flatbed scanning window 110 are inserted in the case 140. The positioning board 180 is disposed on an inner wall of the case 140. The barcode pattern 122 is disposed on the positioning board 180, and the positioning board 180 is positioned between the flatbed scanning window 110 and the automatic paper-feeding scanning window 170. The barcode pattern 122 may also be directly disposed on the inner wall of the case 140.

FIG. 5 is a cross-sectional schematic view of a scanner according to another embodiment of the invention. Please refer to FIG. 5, a scanner 500 further includes an automatic paper-feeding device 190 and an ADF scanning window 170. The automatic paper-feeding device 190 has a paper feeding track 194, and paper may be sequentially fed into the paper feeding track 194. The barcode pattern 122 is set in an area 192 of the automatic paper-feeding device 190. The area 192 and the ADF scanning window 170 correspond to each other. The barcode pattern 122 and the ADF scanning window 170 also correspond to each other. When the scanning module 130 is below an automatic paper-feeding scanning window 170, the scanning module 130 may capture the image of the barcode pattern 122.

### Regarding the Home Position Method of the Scanning Module

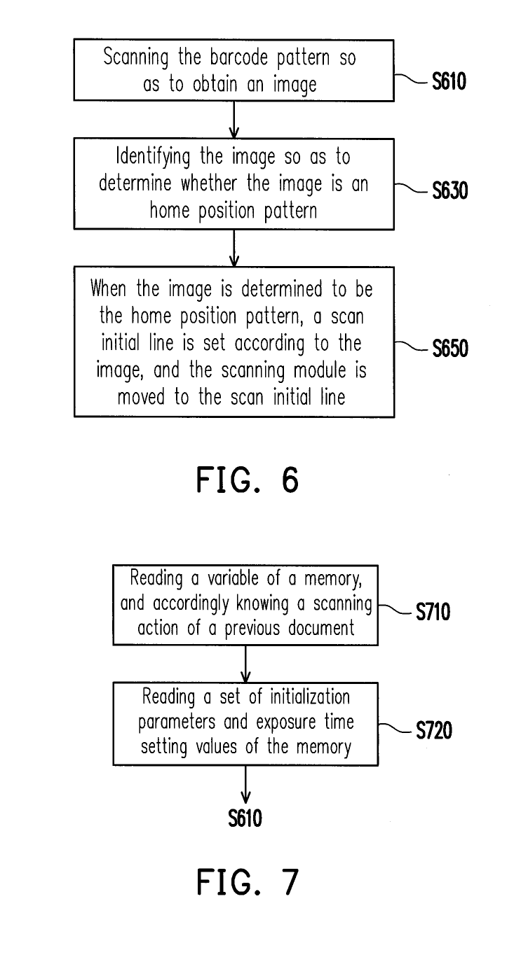

Based on the description of the aforesaid embodiments, FIG. 6 is a flow chart showing a home position method of a scanning module according to an embodiment of the invention. Please refer to FIGS. 1, 3, and 6, the home position method of the embodiment includes the following steps.

The barcode pattern 122 is scanned so as to obtain an image, wherein the barcode pattern 122 is set in an area outside of a flatbed scanning window 110 of the scanner 100 (step S610).

The image is identified so as to determine whether the image is a home position pattern (step S630).

When the image is determined to be the home position pattern, a scan initial line S0 is set according to the image, and the scanning module 130 is moved to the scan initial line S0 (step S650).

FIG. 7 is a flow chart showing a home position method of a scanning module according to another embodiment of the invention. Because of mechanical failure or power failure, before the step S610 of scanning the barcode pattern 122 may include the following steps.

The control unit 160 reads a variable of the memory 150, so as to know whether or not a scanning action of a previous document of the scanner 100 ended normally (step S710).

The control unit 160 reads a set of initialization parameters and exposure time setting values of the memory 150, and then the control unit 160 controls the scanning module 130 to move in the first direction (x direction) and perform scanning (step S720).

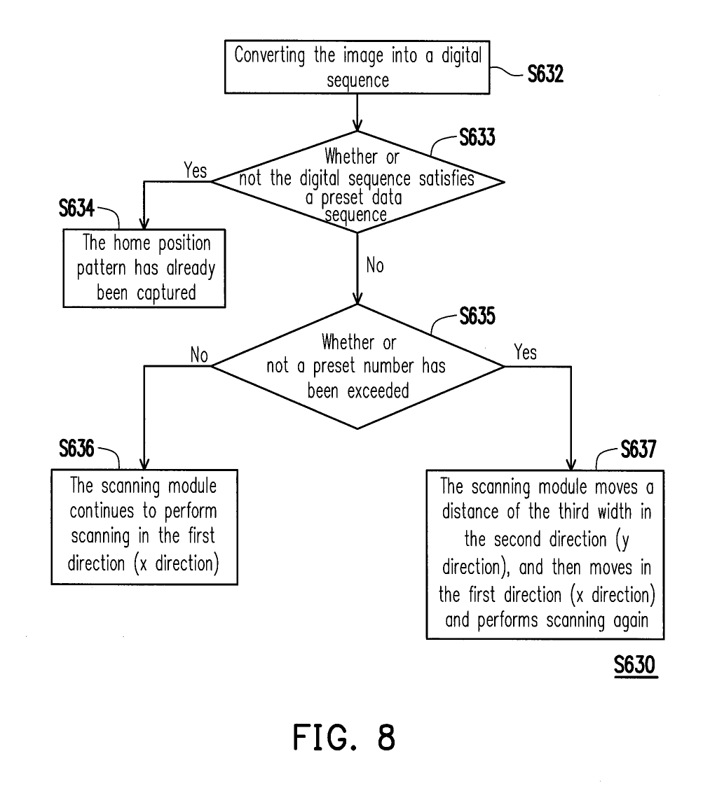

FIG. 8 is a flow chart of the method of identifying the image. Please refer to FIGS. 1, 3, and 8, the step S630 of identifying the image of the embodiment includes the following steps.

The image is converted into a digital sequence, wherein the digital sequence may be a combination sequence of 0 and 1 (step S632).

The digital sequence is determined whether or not it satisfies a preset data sequence of the scanner 100 (step S633).

When the digital sequence satisfies the preset data sequence of the scanner 100, the scanning module 130 has already captured the home position pattern (step S634).

It is determined whether or not a preset number (preset value) is exceeded (step S635).

When the number of times the scanning module 130 does not capture the image does not exceed a preset value, the control unit 160 controls the scanning module 130 to perform scanning in the first direction (x direction) (step S636).

When the number of times the scanning module 130 does not capture the image exceeds a preset value, the control unit 160 controls the scanning module 130 to move a distance of the third width W3 in the second direction (y direction), and then move in the first direction (x direction) and perform scanning again (step S637).

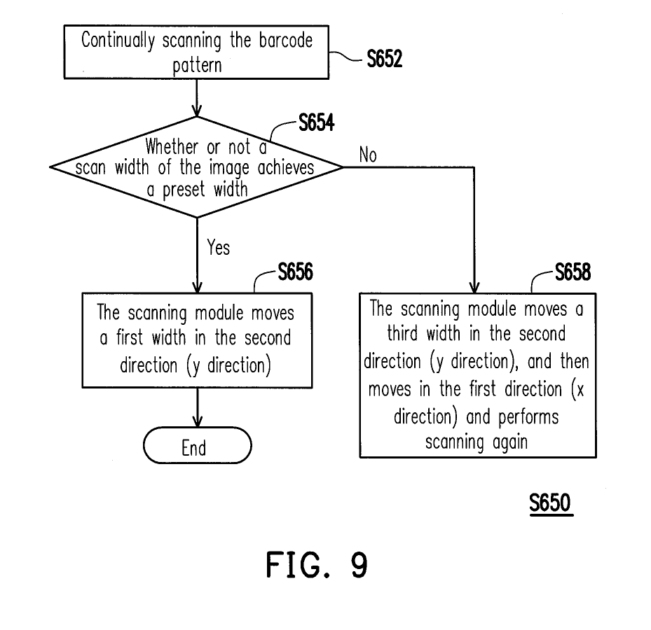

FIG. 9 is a flow chart of the method of identifying the image. Please refer to FIGS. 1, 3, and 9, when the home position pattern is the determination result, the step S650 of setting a scan initial line S0 according to the image also includes the following steps.

The barcode pattern is continually scanned (step S652).

It is determined whether or not a scan width of the image achieves a preset width BW (step S654).

When the scan width of the image achieves the preset width BW, the scanning module 130 moves a first width W1 in the second direction (y direction) towards the barcode pattern 122, and is accordingly positioned to the scan initial line S0 (step S656).

When the scan width of the image does not achieve the preset width BW, the scanning module 130 moves a third width W3 in the second direction (y direction), and then moves in the first direction (x direction) to perform scanning again (step S658).

In summary, a scanner and a home position method of a scanning module of the embodiment allows the scanning module to be home positioned to the scan initial line, and does not require an additional protection wall and home sensor. The scanner may be applied in a multi function peripheral (MFP), a scanning device, a copy machine, or other machines. Using the scanner of the invention as an example, the different scanning machines of conventional art only require an additional barcode pattern, and a precise home positioning of the scanning module may be performed according to the position of the barcode pattern. The barcode pattern has at least the following advantages: easy to identify, reliable, efficient, and a low production cost. Thus, the amount of components is reduced, the assembly process is simplified, and production cost is saved.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A home position method of a scanning module of a scanner, comprising:
scanning a barcode pattern so as to obtain an image, wherein the barcode pattern is set in an area outside of a flatbed scanning window of the scanner;
identifying the image so as to determine whether the image is an home position pattern; and
when the image is determined to be the home position pattern, setting a scan initial line according to the image and moving the scanning module to the scan initial line.

2. The home position method of the scanning module of the scanner as claimed in claim 1, wherein the step of identifying the image comprises:
converting the image into a digital sequence, wherein when the digital sequence satisfies a preset data sequence of the scanner, the scanning module has already captured the home position pattern.

3. The home position method of the scanning module of the scanner as claimed in claim 1, wherein the step of setting the scan initial line according to the image comprises:
continually scanning the barcode pattern, and when a scan width of the image achieves a preset width, moving the scanning module a first width in a direction opposite to the direction of scanning the barcode pattern, and accordingly positioning the scanning module to the scan initial line.

4. The home position method of the scanning module of the scanner as claimed in claim 3, wherein the first width is greater than a width of the barcode pattern.

5. The home position method of the scanning module of the scanner as claimed in claim 3, wherein when the scan width of the image arrives exactly at the preset width, the scanning module is defined as positioned on a first scanning line, and the first scanning line is distanced from the scan initial line by the first width; wherein a second scanning line is defined, the second scanning line is distanced from the first scanning line by a second width, and the second scanning line is distanced from the scan initial line by a third width, and the third width is equal to the combination of the first width and the second width; and wherein a direction from the first scanning line to the second scanning line is defined as a first direction, and a direction from the first scanning line to the scan initial line is defined as a second direction.

6. The home position method of the scanning module of the scanner as claimed in claim 5, wherein the scanning module scans in the first direction so as to capture the image.

7. The home position method of the scanning module of the scanner as claimed in claim 5, wherein in the step of continually scanning the barcode pattern, when the scan width of the image does not achieve the preset width, the scanning module moves a distance of the third width in the second direction, and then moves in the first direction and performs scanning.

8. The home position method of the scanning module of the scanner as claimed in claim 5, wherein when the number of times the scanning module does not capture the image exceeds a preset value, the scanning module moves a distance of the third width in the second direction, and then moves in the first direction and performs scanning.

9. The home position method of the scanning module of the scanner as claimed in claim 5, wherein before the step of scanning the barcode pattern further comprises:
reading a variable of a memory, and accordingly knowing whether or not a scanning action of a previous document of the scanner ended normally.

10. The home position method of the scanning module of the scanner as claimed in claim 9, wherein after the step of reading the variable of the memory further comprises:
if the scanning action of the previous document did not have a normal ending, then the scanning module performs scanning in the first direction; otherwise, if the scanning action of the previous document did have a normal ending, then the scanning module first moves a distance of the third width in the second direction, and then moves in the first direction and performs scanning.

11. The home position method of the scanning module of the scanner as claimed in claim 10, wherein after the scanning module moves in the second direction a distance of the third width, a set of initialization parameters and exposure time setting values of the memory are read, and then the scanning module moves in the first direction and performs scanning.

12. The home position method of the scanning module of the scanner as claimed in claim 1, wherein the barcode pattern is disposed on a positioning board of the scanner, and the positioning board is positioned between the flatbed scanning window and an automatic paper-feeding scanning window.

13. The home position method of the scanning module of the scanner as claimed in claim 1, wherein the barcode pattern is disposed on an automatic paper-feeding device, and when the scanning module is below an automatic paper-feeding scanning window, the scanning module captures the image of the barcode pattern.

14. A scanner, comprising:
a flatbed scanning window;
a barcode pattern, set in an area outside the flatbed scanning window;
a scanning module, comprising an image sensor; and
a control unit, coupled to the scanning module, used to control the operation of the scanning module;
wherein the scanning module performs scanning towards a barcode pattern to obtain an image; wherein the control unit identifies the image, so as to determine whether the image is an home position pattern; wherein when the image is determined to be the home position pattern, the control unit sets a scan initial line according to the image and moves the scanning module to the scan initial line.

15. The scanner as claimed in claim 14, further comprising:
a memory, for storing a preset data sequence;
wherein the memory is coupled to the control unit, and the control unit is further used to control the operation of the memory; wherein when the control unit identifies the image, the image is converted to a digital sequence, and when the digital sequence satisfies a preset data sequence, the scanning module has already captured the home position pattern.

16. The scanner as claimed in claim 14, wherein the control unit further controls the scanning module to continuously scan the barcode pattern, and when the scan width of the image achieves the preset width, the scanning module moves a first width in a direction opposite to the direction of scanning the barcode pattern, and is accordingly positioned to the scan initial line in response to the control of the control unit.

17. The scanner as claimed in claim 16, wherein the first width is greater than a width of the barcode pattern.

18. The scanner as claimed in claim 16, wherein when the scan width of the image arrives exactly at the preset width, the scanning module is defined as positioned on a first scanning line, and the first scanning line is distanced from the scan initial line by the first width; wherein a second scanning line is defined, the second scanning line is distanced from the first scanning line by a second width, and the second scanning line is distanced from the scan initial line by a third width, and the third width is equal to the combination of the first width and the second width; and wherein a direction from the first scanning line to the second scanning line is defined as a first direction, and a direction from the first scanning line to the scan initial line is defined as a second direction.

19. The scanner as claimed in claim 18, wherein the scanning module scans in the first direction so as to capture the image.

20. The scanner as claimed in claim 18, wherein when the scan width of the image does not achieve the preset width, the control unit controls the scanning module to move a distance of the third width in the second direction, and then move in the first direction and perform scanning.

21. The scanner as claimed in claim 18, wherein when the number of times the scanning module does not capture the image exceeds a preset value, the control unit controls the scanning module to move a distance of the third width in the second direction, and then move in the first direction and perform scanning

22. The scanner as claimed in claim 18, wherein the memory is further used to store a variable, and the control unit reads the variable, so as to know whether or not a scanning action of a previous document of the scanner ended normally.

23. The scanner as claimed in claim 18, wherein when the control unit learns the previous document did not have a normal ending, then the control unit controls the scanning module to perform scanning in the first direction; otherwise, when the control unit learns the previous document did have a normal ending, then the control unit controls the scanning module to first move a distance of the third width in the second direction, and then move in the first direction and perform scanning.

24. The scanner as claimed in claim 23, wherein after the control unit controls the scanning module to move a distance of the third width in the second direction, the control unit reads a set of initialization parameters and exposure time setting values of the memory, and then the control unit controls the scanning module to move in the first direction and perform scanning.

25. The scanner as claimed in claim 14, further comprising:
a case;
an automatic paper-feeding scanning window, inserted in the case with the flatbed scanning window; and
a positioning board, disposed on an inner wall of the case;
wherein the barcode pattern is disposed on the positioning board, and the positioning board is positioned between the flatbed scanning window and the automatic paper-feeding scanning window.

26. The scanner as claimed in claim 14, further comprising:
an automatic paper-feeding device; and
an automatic paper-feeding scanning window;
wherein the barcode pattern is disposed on the automatic paper-feeding device, and when the scanning module is below the automatic paper-feeding scanning window, the scanning module captures the image of the barcode pattern.
